(19) United States
(12) Patent Application Publication
(10) Pub. No.: US 2024/0316692 A1
(43) Pub. Date: Sep. 26, 2024

(54) LASER PROCESSING APPARATUS

(71) Applicant: DISCO CORPORATION, Tokyo (JP)

(72) Inventor: Nobuyuki KIMURA, Tokyo (JP)

(21) Appl. No.: 18/609,620

(22) Filed: Mar. 19, 2024

(30) Foreign Application Priority Data
Mar. 23, 2023 (JP) 2023-046212

(51) Int. Cl. B23K 26/06

(52) U.S. Cl. CPC B23K 26/0643; B23K 26/0648; B23K 26/0665

(57) ABSTRACT

A laser processing apparatus includes a holding table for holding a workpiece thereon, a laser oscillator for emitting a laser beam, a polygon mirror having a plurality of reflecting facets for scanning the laser beam emitted by the laser oscillator, a beam condenser for converging the laser beam scanned by the polygon mirror and applying the converged laser beam to the workpiece, and an irradiated facet specifying unit for specifying an irradiated facet of the polygon mirror to which the laser beam is applied among the reflecting facets.

### BACKGROUND OF THE INVENTION

### Field of the Invention

The present invention relates to a laser processing apparatus for processing a workpiece with a laser beam.

### Description of the Related Art

According to the process of manufacturing device chips, there are used wafers from which to manufacture the device chips, each of the wafers having a plurality of devices fabricated in respective areas demarcated thereon by a grid of streets or projected dicing lines. The wafer is divided along the streets into pieces referred to as device chips including the respective devices. The device chips will be incorporated in various electronic appliances such as cellular phones, personal computers, etc.

For dividing a wafer, it has been customary to use a cutting apparatus that cuts workpieces with an annular cutting blade. Recent years have seen the development of a laser beam process in progress. According to the laser beam process, a laser processing apparatus applies a laser beam to a wafer, dividing the wafer into device chips. The laser processing apparatus includes a holding table for holding a workpiece, i.e., a wafer, thereon and a laser beam applying unit for applying a laser beam to the workpiece held on the holding table. The laser beam applying unit has an optical system including various optical elements such as mirrors and lenses. The optical system guides and applies the laser beam to the workpiece. When the laser beam applying unit applies a laser beam that is absorbable by a workpiece to the workpiece, the laser beam ablates the workpiece, dividing the workpiece into a plurality of pieces.

Specifically, when the laser beam is applied to the workpiece, the regions of the workpiece that are irradiated with the laser beam are melted, producing meltage or debris. If the meltage is resolidified, it refills or recasts the melted regions, tending to disrupt efficient laser beam processing. In an effort to alleviate the shortcoming, there has been proposed in the art a technique of scanning a workpiece with a laser beam at a high speed repeatedly a number of times by reflecting the laser beam using a polygon mirror incorporated in the optical system of the laser beam applying unit (see, for example, Japanese Patent Laid-open No. 2019-51536). The proposed technique makes it possible to process the workpiece with the laser beam while preventing the meltage from being resolidified, resulting in an increased laser beam processing efficiency.

### SUMMARY OF THE INVENTION

The polygon mirror incorporated in the optical system of the laser beam applying unit of the laser processing apparatus is shaped as a polygonal prism having a plurality of reflecting facets or mirror facets. When the laser beam is applied to the polygon mirror that is rotating at a high speed, the laser beam is reflected by each of the reflecting facets as its angle varies continuously, scanning the workpiece. Since the polygon mirror is rotating, the laser beam is applied to and reflected by the reflecting facets in succession, repeatedly scanning the workpiece in successive strokes.

Ideally, a polygon mirror should be shaped as a regular polygonal prism having all reflecting facets lying parallel to a rotational axis about which the polygon mirror rotates. Actually, however, because of errors that are liable to occur when the polygon mirror is manufactured, it is difficult to equalize the angles of all the reflecting facets with respect to the rotational axis of the polygon mirror, and the angles of the reflecting facets with respect to the rotational axis of the polygon mirror tend to suffer slight variations. Accordingly, when the laser beam is applied to each of the reflecting facets, the laser beam is thus likely to be reflected in a different direction and applied to a region of the workpiece that is not intended to be irradiated with the laser beam.

The laser beam reflected by the polygon mirror is thus liable to be applied to the workpiece at different positions due to the variations in the angles of the reflecting facets with respect to the rotational angle of the polygon mirror. As means for solving this, it is possible to correct the positions where the laser beam is applied to the respective reflecting facets of the polygon mirror. However, it has not been customary for the laser processing apparatus to monitor in real time which reflecting facet of the polygon mirror is irradiated with the laser beam at any time while the workpiece is being processed by the laser beam on the laser processing apparatus. Consequently, it has been difficult to perform control for adjusting the positions where the laser beam is applied to the respective reflecting facets of the polygon mirror.

It is therefore an object of the present invention to provide a laser processing apparatus that is capable of monitoring the positions where a laser beam is applied to the respective reflecting facets of a polygon mirror.

In accordance with an aspect of the present invention, there is provided a laser processing apparatus including a holding table for holding a workpiece thereon, a laser oscillator for emitting a laser beam, a polygon mirror having a plurality of reflecting facets for scanning the laser beam emitted by the laser oscillator, a beam condenser for converging the laser beam scanned by the polygon mirror and applying the converged laser beam to the workpiece, and an irradiated facet specifying unit for specifying an irradiated facet of the polygon mirror to which the laser beam is applied among the reflecting facets.

Preferably, the laser processing apparatus further includes a position adjusting unit for adjusting the position where the laser beam is applied to the irradiated facet with respect to each of the reflecting facets. Preferably, the irradiated facet specifying unit includes a reference facet detecting unit for detecting a predetermined reference facet from among the reflecting facets, and the irradiated facet specifying unit specifies the irradiated facet on the basis of the reference facet. Preferably, the reference facet detecting unit includes a light emitting unit for emitting a light beam to be applied to the reflecting facets and a light detecting unit for detecting the light beam reflected by the reflecting facets, the reference facet has a reflectance different from a reflectance of the reflecting facets other than the reference facet with respect to the light beam applied to the reflecting facets, and the irradiated facet specifying unit specifies the reference facet on the basis of an amount of light of the light beam detected by the light detecting unit.

The laser processing apparatus according to the aspect of the present invention includes the irradiated facet specifying unit for specifying the irradiated facet of the polygon mirror to which the laser beam is applied among the reflecting facets. The irradiated facet specifying unit can monitor the position where the laser beam is applied to the polygon mirror when the laser processing apparatus performs a laser processing operation on the workpiece.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 a perspective view of a laser processing apparatus according to an embodiment of the present invention;

FIG. 2 is a perspective view of a workpiece to be processed by the laser processing apparatus;

FIG. 3 is a schematic diagram, partly in block form, of a laser beam applying unit of the laser processing apparatus;

FIG. 4 is a perspective view of a polygon mirror incorporated in the laser beam applying unit;

FIG. 5A is an enlarged fragmentary cross-sectional view of each of reflecting facets of the polygon mirror other than a reference facet thereof;

FIG. 5B is an enlarged fragmentary cross-sectional view of the reference facet of the polygon mirror;

FIG. 6A is a graph illustrating the reflectance of the reflecting facets of the polygon mirror other than the reference facet thereof with respect to light beams applied thereto;

FIG. 6B is a graph illustrating the reflectance of the reference facet of the polygon mirror with respect to light beams applied thereto;

FIG. 7 is a perspective view, partly in block form, of the laser processing apparatus as it adjusts the position where a laser beam is applied to the reflecting facets of the polygon mirror; and

FIG. 8 is an enlarged fragmentary plan view of the workpiece.

### DETAILED DESCRIPTION OF THE PREFERRED EMBODIMENT

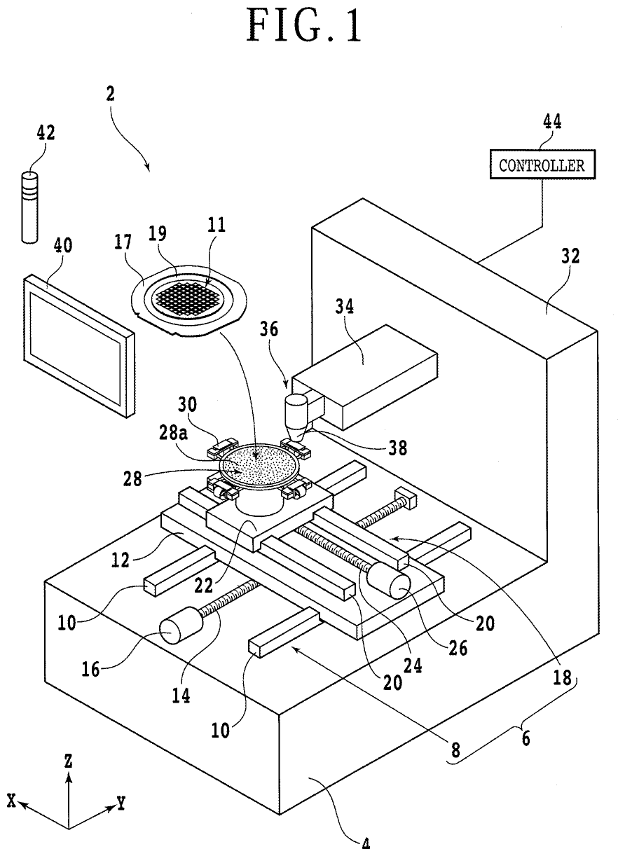

A preferred embodiment of the present invention will be described below with reference to the accompanying drawings. First, a structural example of a laser processing apparatus according to the present embodiment will be described below. FIG. 1 illustrates in perspective the laser processing apparatus, denoted by 2, according to the present embodiment. In FIG. 1, the laser processing apparatus 2 is illustrated in reference to a three-dimensional coordinate system having an X-axis, a Y-axis, and a Z-axis. The X-axis, which represents processing feed directions, first horizontal directions, or leftward and rightward directions, and the Y-axis, which represents indexing feed directions, second horizontal directions, or forward and rearward directions, extend perpendicularly to each other. The Z-axis, which represents upward and downward directions, heightwise directions, or vertical directions, extends perpendicularly to the X-axis and the Y-axis.

The laser processing apparatus 2 includes a base 4 that supports thereon various components of the laser processing apparatus 2. The base 4 has an upper flat surface lying generally parallel to a horizontal plane, i.e., an XY-plane, defined by the X-axis and the Y-axis. A moving unit or assembly 6 is supported on the upper flat surface of the base 4. The moving unit 6 includes a Y-axis moving unit or Y-axis moving mechanism 8 and an X-axis moving unit or X-axis moving mechanism 18.

The Y-axis moving unit 8 includes a pair of Y-axis guide rails 10 disposed on the upper surface of the base 4 and extending along the Y-axis. The Y-axis moving unit 8 also includes a Y-axis movable table 12 shaped as a flat plate slidably mounted on the Y-axis guide rails 10 for sliding movement along the Y-axis. A nut, not depicted, is fixedly mounted on a reverse side, i.e., a lower surface, of the Y-axis movable table 12. The nut is operatively threaded over a Y-axis ball screw 14 disposed between the Y-axis guide rails 10 and extending along the Y-axis. The Y-axis ball screw 14 has an end coupled to an output shaft of a Y-axis stepping motor 16 disposed on the base 4. When the Y-axis stepping motor 16 is energized, it rotates the Y-axis ball screw 14 about its longitudinal central axis, causing the nut to move the Y-axis movable table 12 slidingly along the Y-axis guide rails 10 along the Y-axis.

The X-axis moving unit 18 includes a pair of X-axis guide rails 20 disposed on a face side, i.e., an upper surface, of the Y-axis movable table 12 and extending along the X-axis. The X-axis moving unit 18 also includes an X-axis movable table 22 shaped as a flat plate slidably mounted on the X-axis guide rails 20 for sliding movement along the X-axis. A nut, not depicted, is fixedly mounted on a reverse side, i.e., a lower surface, of the X-axis movable table 22. The nut is operatively threaded over an X-axis ball screw 24 disposed between the X-axis guide rails 20 and extending along the X-axis. The X-axis ball screw 24 has an end coupled to an output shaft of an X-axis stepping motor 26 disposed on the Y-axis movable table 12. When the X-axis stepping motor 26 is energized, it rotates the X-axis ball screw 24 about its longitudinal central axis, causing the nut to move the X-axis movable table 22 slidingly along the X-axis guide rails 20 along the X-axis.

A holding table, i.e., a chuck table, 28 is coupled to the moving unit 6. Specifically, the holding table 28 is disposed on a face side, i.e., an upper surface, of the X-axis movable table 22. The holding table 28 holds thereon a workpiece 11 that is to be processed by the laser processing apparatus 2.

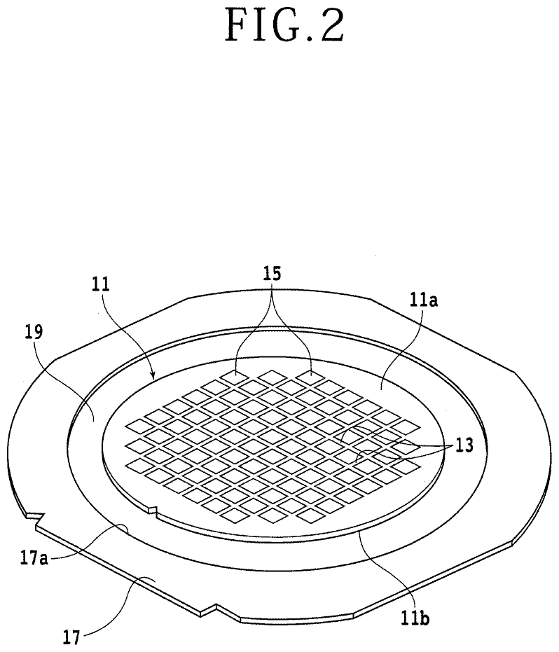

FIG. 2 illustrates the workpiece 11 in perspective. The workpiece 11 is, for example, a disk-shaped wafer made of a semiconductor material such as monocrystalline silicon. The workpiece 11 has a face side 11a and a reverse side 11b, which are substantially parallel to each other. The face side 11a includes a plurality of areas demarcated by a grid of streets or projected dicing lines 13 established thereon. The areas have respective devices 15 such as integrated circuits (ICs), large-scale-integration (LSI) circuits, light-emitting diodes (LEDs), or microelectromechanical systems (MEMS) devices fabricated therein. However, the workpiece 11 is not limited to any particular types, materials, shapes, structures, and sizes. The workpiece 11 may be, for example, a substrate or wafer made of a semiconductor material other than silicon, such as GaAs, InP, GaN, or SiC, or sapphire, glass, ceramic, resin, or metal. The devices 15 are not limited to any particular types, numbers, shapes, structures, sizes, and layouts. The workpiece 11 may even be free of the devices 15.

When the workpiece 11 is to be processed by the laser processing apparatus 2 illustrated in FIG. 1, the workpiece 11 is supported by an annular frame 17 for easy handling at the time it is transported or held in position, for example. The frame 17 is made of a metal material such as stainless steel (SUS), and has a central circular opening 17a defined centrally therein and extending thicknesswise therethrough. The opening 17a is larger than the workpiece 11 in diameter.

A circular sheet 19 is fixed to the workpiece 11 and the frame 17. The sheet 19 may be, for example, a tape including a circular film-shaped base layer and an adhesive layer, i.e., a glue layer, affixed to the base layer. The base layer is made of resin such as polyolefin, polyvinyl chloride, or polyethylene terephthalate. The adhesive layer is made of an adhesive such as an epoxy-based, acryl-based, or rubber-based adhesive. The adhesive layer may alternatively be made of ultraviolet-curable resin. The workpiece 11, the frame 17, and the sheet 19 are assembled together as follows: With the workpiece 11 disposed centrally within the opening 17a in the frame 17, the sheet 19 has its central portion affixed to the reverse side 11b of the workpiece 11, opposite the face side 11a, and has its outer circumferential portion affixed to the frame 17. The workpiece 11 is thus supported on the frame 17 by the sheet 19.

As illustrated in FIG. 1, the holding table 28 has an upper flat surface lying generally parallel to the horizontal plane, i.e., the XY-plane, and providing a holding surface 28a for holding the workpiece 11 thereon. The holding surface 28a is fluidly connected to a suction source, not depicted, such as an ejector, through a fluid channel, not depicted, defined in the holding table 28 and a valve, not depicted. A plurality of clamps 30 for gripping and securing the frame 17 in place are disposed around the holding table 28.

When the Y-axis movable table 12 is moved along the Y-axis, the holding table 28 is also moved along the Y-axis. When the X-axis movable table 22 is moved along the X-axis, the holding table 28 is also moved along the X-axis. The holding table 28 is rotatable about its central vertical axis generally parallel to the Z-axis by a rotary actuator, not depicted, such as an electric motor, coupled to the holding table 28.

The laser processing apparatus 2 includes a support structure 32 shaped as a rectangular parallelepiped disposed at a rear end of the base 4 behind the moving unit 6 and the holding table 28. The support structure 32 protrudes upwardly from the upper surface of the base 4 and has a face side, i.e., a front surface, lying parallel to a XZ plane defined by the X-axis and the Z-axis. A columnar support arm 34 protrudes forwardly from the face side of the support structure 32.

The laser processing apparatus 2 further includes a laser beam applying unit 36 for applying a laser beam to the workpiece 11 held on the holding table 28. The laser beam applying unit 36 includes a laser processing head 38 mounted on a distal end of the support arm 34. The laser processing head 38 emits the laser beam to the workpiece 11 held on the holding table 28, processing the workpiece 11.

An image capturing unit, not depicted, may be mounted on the distal end of the support arm 34. The image capturing unit includes an image sensor such as a charge-coupled-device (CCD) sensor or a complementary-metal-oxide-semiconductor (CMOS) sensor, and captures an image of the workpiece 11 held on the holding table 28 when energized. The image capturing unit is not limited to any particular types and may be a visible-light camera or an infrared camera, for example. The workpiece 11 and the laser processing head 38 are positioned relatively to each other on the basis of an image captured of the workpiece 11 by the image capturing unit.

The support arm 34 may be operatively connected to the support structure 32 by a Z-axis moving unit, not depicted, that can move the support arm 34 along the Z-axis. The Z-axis moving unit may be, for example, a ball-screw-type moving mechanism disposed on the face side of the support structure 32. When the Z-axis moving unit is actuated, it moves, i.e., lifts or lowers, the support arm 34 along the Z-axis to adjust the vertical position of the focused spot of the laser beam emitted from the laser processing head 38 and to perform focusing of the image capturing unit.

The laser processing apparatus 2 further includes a display unit, i.e., a display section or a display device, 40 for displaying various pieces of information regarding the laser processing apparatus 2. The display unit 40 may be a touch panel, for example. The touch panel displays an interactive touchscreen that an operator touches to enter information into the laser processing apparatus 2. Therefore, the touch panel also functions as an input unit, i.e., an input section or an input device, for entering various pieces of information into the laser processing apparatus 2, and is used as a user interface. Alternatively, a separate input unit such as a mouse or a keyboard, for example, may be used independently of the display unit 40.

The laser processing apparatus 2 includes a signaling unit, i.e., a signaling section or a signaling device, 42 for signaling to the operator, giving information about the laser processing apparatus 2. For example, the signaling unit 42 is an indicator lamp, i.e., a warning lamp, which is continuously energized or blinks when the laser processing apparatus 2 malfunctions, indicating an error to the operator. However, the signaling unit 42 is not limited to any particular types. The signaling unit 42 may alternatively be a speaker that gives information to the operator by way of sound or speech.

The laser processing apparatus 2 further includes a controller, i.e., a control unit, a control section, or a control device, 44 for controlling the laser processing apparatus 2. The controller 44 is electrically connected to the components, including the moving unit 6, the holding table 28, the clamps 30, the laser beam applying unit 36, the display unit 40, and the signaling unit 42, of the laser processing apparatus 2. The controller 44 sends control signals to the components of the laser processing apparatus 2 to operate the laser processing apparatus 2. For example, the controller 44 includes a computer, for example. Specifically, the controller 44 includes a processing unit for performing processing operations such as arithmetic operations required to operate the laser processing apparatus 2 and a storage unit for storing various items of information including data and programs that are used to operate the laser processing apparatus 2. The processing unit includes a processor such as a central processing unit (CPU). The storage unit includes a memory such as a read only memory (ROM) and a random access memory (RAM).

For processing the workpiece 11 on the laser processing apparatus 2, the workpiece 11 is held on the holding table 28. Specifically, for example, the workpiece 11 is placed on the holding table 28 with the face side 11a exposed upwardly and the reverse side 11b, i.e., the sheet 19, facing the holding surface 28a. The frame 17 are secured in place by the clamps 30. Then, a suction force, i.e., a negative pressure, from the suction source is applied to the holding surface 28a, holding the workpiece 11 under suction on the holding table 28 with the sheet 19 interposed therebetween.

Then, the laser processing head 38 emits and applies the laser beam to the workpiece 11 on the holding table 28, performing a predetermined laser processing operation on the workpiece 11. The laser beam is applied under irradiating conditions established appropriately according to the details of the laser processing operation on the workpiece 11. For example, the laser beam is applied under irradiating conditions for ablating the workpiece 11. Specifically, the laser beam has a wavelength selected to allow at least a part of the laser beam to be absorbed by the workpiece 11. In other words, the laser beam is absorbable by the workpiece 11. Other irradiating conditions under which the laser beam is applied to the workpiece 11 are also appropriately established to ablate the workpiece 11. For example, in a case where the workpiece 11 is a monocrystalline silicon wafer, the irradiating conditions are established as follows:
Wavelength: 355 nm
Average output power: 2 W
Repetitive frequency: 200 kHz
Processing feed speed: 400 mm/s

The laser beam is applied to the workpiece 11 along the streets 13 (see FIG. 2) thereof to ablate the workpiece 11, thereby dividing the workpiece 11 along the streets 13. Specifically, the holding table 28 is turned to align a predetermined one of the streets 13 with the X-axis. The position of the holding table 28 along the Y-axis is adjusted to align the focused spot of the laser beam and the position of the predetermined street 13 along the Y-axis with each other. Then, the laser processing head 38 applies the laser beam to the workpiece 11 while the holding table 28 is moved, i.e., processing-fed, along the X-axis, i.e., the holding table 28 and the laser processing head 38 are being moved relatively to each other along the X-axis, so that the laser beam is applied to the workpiece 11 along the street 13. Thereafter, the same procedure as described above is repeated to apply the laser beam to the workpiece 11 along all of the street 13.

When the laser beam is thus applied to the workpiece 11, the workpiece 11 is ablated by the laser beam along the streets 13, forming laser-processed grooves in the workpiece 11 that extend from the face side 11a to the reverse side 11b thereof along the streets 13. The workpiece 11 is now divided along the streets 13 into a plurality of device chips each having one of the devices 15 (see FIG. 2). If it is difficult to divide the workpiece 11 along the streets 13 into device chips with a single cycle of irradiating the workpiece 11 with the laser beam, then the laser beam may be applied to the workpiece 11 in a plurality of cycles along each of the streets 13.

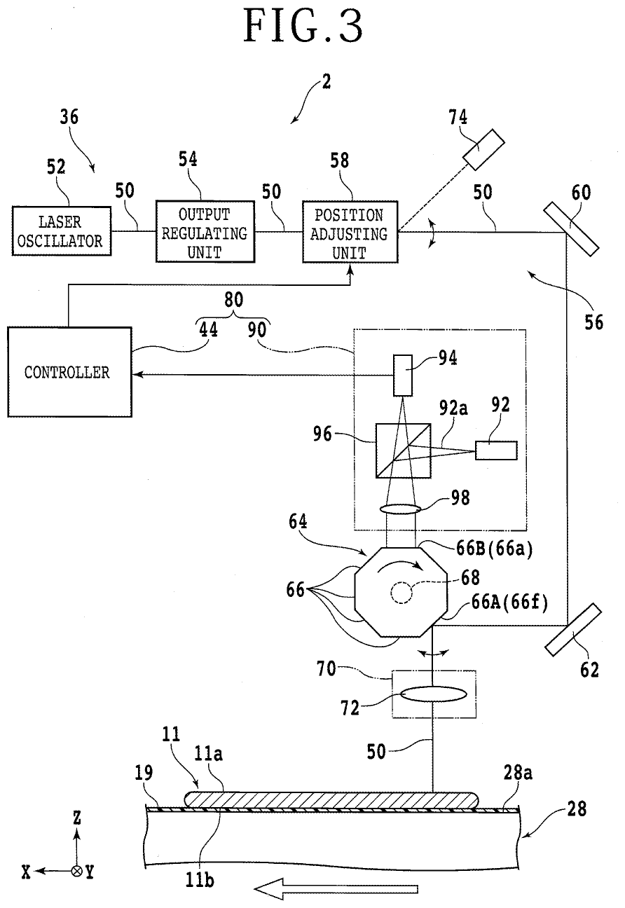

Details of the laser beam applying unit 36 will be described below. FIG. 3 schematically illustrates, partly in block form, the laser beam applying unit 36. The laser beam applying unit 36 applies a laser beam 50 to the workpiece 11 to perform a laser processing operation such as an ablating operation on the workpiece 11.

The laser beam applying unit 36 includes a laser oscillator 52 such as YAG laser, YVO₄ laser, or YLF laser, for emitting the laser beam 50 and an output regulating unit 54 such as an attenuator for regulating the output power of the pulsed laser beam 50 emitted from the laser oscillator 52. The laser beam applying unit 36 also includes an optical system 56 for guiding the laser beam 50 to the workpiece 11 held on the holding table 28. The optical system 56 includes a plurality of optical elements for controlling the direction of travel of the laser beam 50, the configuration of the laser beam 50, and the position of the focused spot of the laser beam 50.

Specifically, the optical system 56 includes a position adjusting unit 58 for adjusting the position to be irradiated with the laser beam 50, i.e., the direction of travel of the laser beam 50. The position adjusting unit 58 changes the direction of travel of the laser beam 50 emitted from the laser oscillator 52 and having its output power regulated by the output regulating unit 54, thereby adjusting the position on a polygon mirror 64, to be described later, to be irradiated with the laser beam 50. The position adjusting unit 58 may be, for example, an acousto-optic deflector (AOD), an electro-optic deflector (EOD), a galvanoscanner, or an optical MEMS. However, the position adjusting unit 58 is not limited to any particular configurations as long as it is able to adjust the direction of travel of the laser beam 50.

The optical system 56 also includes mirrors 60 and 62 and the polygon mirror 64 for reflecting the laser beam 50. The mirrors 60 and 62 may be, for example, a dielectric multilayered film mirror. The laser beam 50 emitted from the position adjusting unit 58 is reflected by reflecting surfaces of the mirrors 60 and 62 and applied to the polygon mirror 64. The polygon mirror 64 is shaped as a polygonal prism having on its outer peripheral side a plurality of flat reflecting facets or mirror facets 66 for reflecting the laser beam 50. Each of the reflecting facets 66 is joined to a pair of adjacent reflecting facets 66 on both sides thereof, and the junction between two adjacent reflecting facets 66 provides one of the vertexes of the outer peripheral side of the polygon mirror 64.

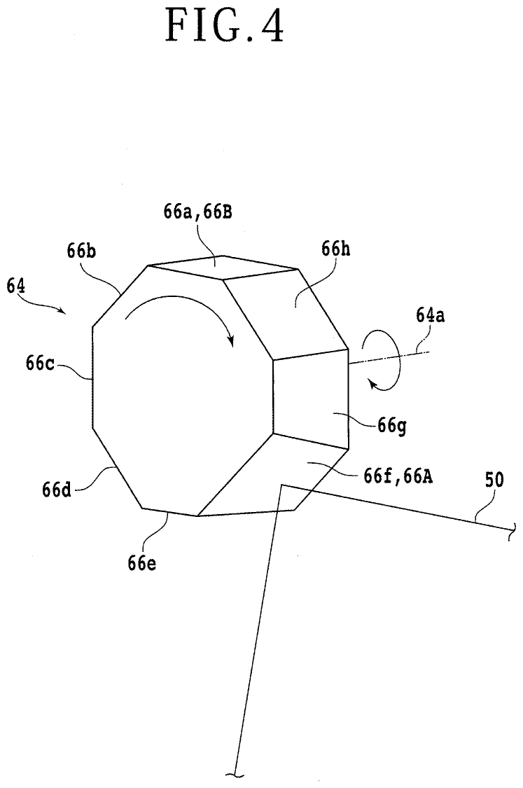

The polygon mirror 64 is coupled to a rotary actuator 68 such as an electric motor for rotating the polygon mirror 64 about its rotational axis 64a (see FIG. 4). The rotational axis 64a extends along the height or thickness direction of the polygon mirror 64 along the Y-axis. When the rotary actuator 68 is energized, it rotates the polygon mirror 64 about the rotational axis 64a.

FIG. 4 illustrates the polygon mirror 64 in perspective. As illustrated in FIG. 4, the polygon mirror 64 is shaped as an octagonal prism, for example, and has eight reflecting facets 66a through 66h, collectively referred to as the reflecting facets 66 above. However, the polygon mirror 64 may be of a different shape and the number of the reflecting facets 66 may be selected depending on the details of a laser processing operation to be performed by the laser processing apparatus 2. One at a time of the reflecting facets 66a through 66h becomes an irradiated facet 66A that is irradiated with the laser beam 50. Specifically, when the polygon mirror 64 is rotated about the rotational axis 64a, the reflecting facets 66a through 66h go successively to a position where they act as the irradiated facet 66A. In addition, at least one of the reflecting facets 66a through 66h is established as a reference facet 66B to be detected by a reference facet detecting unit 90 to be described later (see FIG. 3). In FIG. 4, the reflecting facet 66a is established as the reference facet 66B by way of example. The reference facet 66B will be described in detail later.

When the laser beam 50 is applied to the polygon mirror 64 while the polygon mirror 64 is being rotated about the rotational axis 64a, the laser beam 50 is reflected by the irradiated facet 66A. Upon rotation of the polygon mirror 64, the angle of the irradiated facet 66A with respect to the direction along which the laser beam 50 is applied to the irradiated facet 66A varies continuously. Therefore, the direction of travel of the laser beam 50 reflected by the irradiated facet 66A varies continuously, so that the laser beam 50 is deflected to scan or sweep over a predetermined scan region. When the polygon mirror 64 is rotated in a number of cycles at a high speed about the rotational axis 64a, the reflecting facets 66a through 66h switch successively as the irradiated facet 66A in the order named, enabling the laser beam 50 to scan the scan region in a number of cycles at high speed.

As illustrated in FIG. 3, the optical system 56 includes a beam condenser 70 for converging the laser beam 50. The beam condenser 70 includes a condensing lens 72 such as an fθ lens that converges the laser beam 50 scanned by the polygon mirror 64 and applies the converged laser beam 50 to the workpiece 11. Specifically, the laser beam 50 reflected by the irradiated facet 66A of the polygon mirror 64 is applied to the beam condenser 70 and converged by the condensing lens 72 onto a predetermined position, e.g., the face side 11a of the workpiece 11, the reverse side 11b of the workpiece 11, or within the workpiece 11.

The position adjusting unit 58 changes the direction of travel of the laser beam 50, thereby adjusting the position where the laser beam 50 irradiates the irradiated facet 66A. Accordingly, the position adjusting unit 58 enables the laser beam 50 to irradiate the irradiated facet 66A at a desired position thereon. The position adjusting unit 58 can also change the direction of travel of the laser beam 50 to the extent that deviates from the mirror 60, thereby stopping the laser beam 50 from irradiating the irradiated facet 66A. In other words, the position adjusting unit 58 can control the laser beam 50 to selectively irradiate and not irradiate the irradiated facet 66A, i.e., to selectively turn on and off the laser beam 50 with respect to the irradiated facet 66A.

The optical system 56 should preferably include a beam damper 74 for interrupting the laser beam 50 emitted from the position adjusting unit 58. For stopping the laser beam 50 from irradiating the irradiated facet 66A, the position adjusting unit 58 adjusts the direction of travel of the laser beam 50 to direct the laser beam 50 toward the beam damper 74. When the laser beam 50 is directed toward the beam damper 74, the laser beam 50 is not applied to the mirror 60 and hence is safely stopped from irradiating the irradiated facet 66A.

The optical system 56 includes the optical elements described above. However, the optical elements that make up the optical system 56 are not limited to those described above. For example, the optical system 56 may further include optical elements such as other mirrors and lenses, a polarizing beam splitter (PBS), a diffractive optical element (DOE), and a liquid crystal on silicon-spatial light modulator (LCOS-SLM).

The laser processing apparatus 2 further includes an irradiated facet specifying unit 80 for specifying the irradiated facet 66A to be irradiated with the laser beam 50 among the reflecting facets 66a through 66h of the polygon mirror 64. The irradiated facet specifying unit 80 can monitor in real time which one of the reflecting facets 66a through 66h is being irradiated with the laser beam 50. The irradiated facet specifying unit 80 includes, for example, the controller 44 and the reference facet detecting unit 90 incorporated in the laser beam applying unit 36. The reference facet detecting unit 90 detects the established reference facet 66B among the reflecting facets 66a through 66h of the polygon mirror 64. The controller 44 specifies the irradiated facet 66A to be irradiated with the laser beam 50, on the basis of the reference facet 66B detected by the reference facet detecting unit 90.

Specifically, the reference facet detecting unit 90 includes a light emitting unit, i.e., a light emitter or a light projector, 92 for emitting a light beam, i.e., a detecting light beam, 92a and a light detecting unit, i.e., a light detector, 94 for detecting the light beam 92a. The light beam 92a emitted from the light emitting unit 92 is applied to the reflecting facets 66 of the polygon mirror 64. When the light beam 92a is applied to the reflecting facets 66, they reflect a light beam from the light beam 92a. The reflected light beam is applied to the light detecting unit 94. The reflected light beam is detected by the light detecting unit 94, which detects the intensity of the reflected light beam.

The reference facet detecting unit 90 is appropriately arranged to guide the light beam 92a emitted from the light emitting unit 92 to travel to the reflecting facets 66 and to guide a light beam reflected from the light beam 92a by the reflecting facets 66 to travel to the light detecting unit 94. For example, the reference facet detecting unit 90 includes a polarizing beam splitter 96 and a lens 98. The polarizing beam splitter 96 reflects a light beam from the light beam 92a emitted from the light emitting unit 92 toward the reflecting facets 66 of the polygon mirror 64. The lens 98 converges the light beam reflected by the polarizing beam splitter 96 and guides the converged light beam to travel to the reflecting facets 66 of the polygon mirror 64. The lens 98 may be a collimator lens, for example. The reflected light beam from the reflecting facets 66 travels through the lens 98 and the polarizing beam splitter 96 to the light detecting unit 94. The light beam reflected from the light beam 92a is now detected by the light detecting unit 94.

As described above, at least one of the reflecting facets 66 of the polygon mirror 64 is established as the reference facet 66B to be detected by the reference facet detecting unit 90. The reference facet 66B has a different reflectance with respect to the light beam applied thereto from the reflectance of the other reflecting facets 66 with respect to the light beam applied thereto. For example, the reflecting facets 66 are constructed such that the reflectance of the reference facet 66B with respect to the light beam applied thereto is higher than the reflectance of the other reflecting facets 66 with respect to the light beam applied thereto.

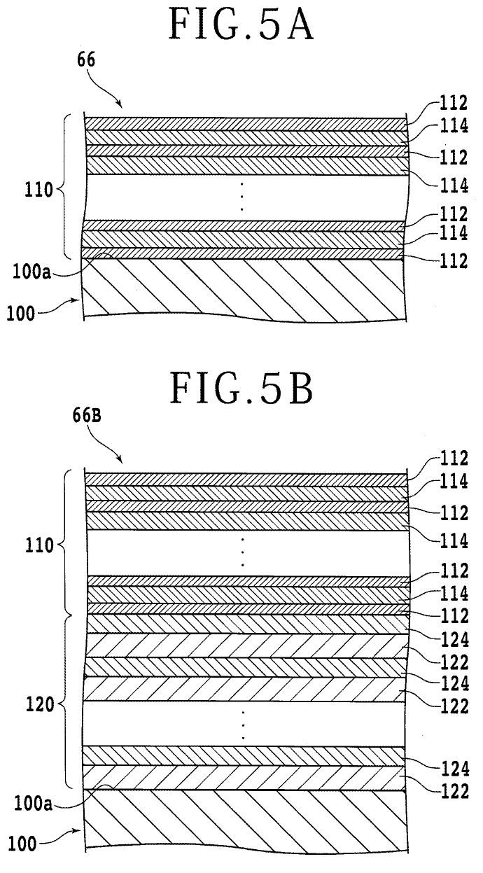

FIG. 5A illustrates in enlarged fragmentary cross section each of the reflecting facets 66 of the polygon mirror 64 other than the reference facet 66B. As illustrated in FIG. 5A, each of the reflecting facets 66 other than the reference facet 66B includes a reflecting layer, i.e., a laser reflecting layer, 110 disposed on a face side 100a of a base 100 of the polygon mirror 64.

The reflecting layer 110 is made up of a laminated assembly of thin films and is reflective of the laser beam 50 (see FIGS. 3 and 4). In a case where the laser beam 50 has a wavelength of 355 nm, for example, the reflecting layer 110 is of such a laminated structure that the reflecting facet 66 has a high reflectance with respect to the laser beam 50 having the wavelength of 355 nm. Specifically, the base 100 of the polygon mirror 64 is made of a hard material such as quartz, and the face side 100a thereof is flat. The reflecting layer 110 on the face side 100a includes a laminated assembly of oxide hafnium films, i.e., HfO₂ films, 112 and oxide silicon films, i.e., SiO₂ films, 114. More specifically, the reflecting layer 110 includes ten oxide hafnium films 112 each having a thickness of 44 nm and nine oxide silicon films 114 each having a thickness of 61 nm. The total of nineteen oxide hafnium films 112 and oxide silicon films 114 are alternately laminated on the face side 100a such that the lowermost and uppermost layers are oxide hafnium films 112. Stated otherwise, the reflecting layer 110 is of such a structure that each of the oxide silicon films 114 is sandwiched by a pair of oxide hafnium films 112, one above and the other beneath the oxide silicon film 114.

FIG. 5B illustrates in enlarged fragmentary cross section the reference facet 66B of the polygon mirror 64. The reference facet 66B is made up of a laminated assembly of a reflecting layer (detecting reflecting layer) 120 and a reflecting layer (laser reflecting layer) 110 on the face side 100a of the base 100.

The reflecting layer 120 is made up of a laminated assembly of thin films as with the reflecting layer 110, and is reflective of the light beam 92a (see FIG. 3) emitted from the light emitting unit 92. In a case where the light beam 92a has a wavelength of 650 nm, for example, the reflecting layer 120 is of such a laminated structure that the reference facet 66B has a high reflectance with respect to the light beam 92a having the wavelength of 650 nm. Specifically, the reflecting layer 120 on the face side 100a includes a laminated assembly of oxide hafnium films, i.e., HfO₂ films, 122 and oxide silicon films, i.e., SiO₂ films, 124. More specifically, the reflecting layer 120 includes four oxide hafnium films 122 each having a thickness of 111 nm and four oxide silicon films 124 each having a thickness of 81 nm. The total of eight oxide hafnium films 122 and oxide silicon films 124 are alternately laminated on the face side 100a such that the lowermost layer is an oxide hafnium film 122 and the uppermost layer is an oxide silicon film 124.

A reflecting layer 110 is laminated on the oxide silicon film 124 as the uppermost layer of the reflecting layer 120. The reflecting layer 110 is of the same structure as the reflecting layer 110 on the face side 100a of the base 100 of each of the reflecting facets 66 other than the reference facet 66B as illustrated in FIG. 5A. The reflecting layer 110 is reflective of the laser beam 50 (see FIGS. 3 and 4). In a case where the laser beam 50 has a wavelength of 355 nm, for example, the reflecting layer 110 includes ten oxide hafnium films 112 and nine oxide silicon films 114 as described above.

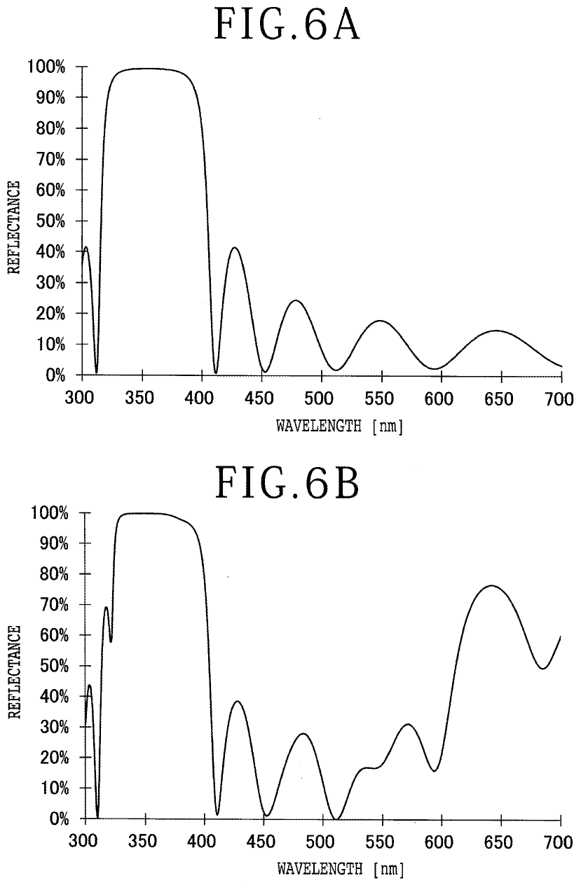

FIG. 6A is a graph illustrating the reflectance of the reflecting facets 66 of the polygon mirror 64 other than the reference facet 66B with respect to light beams applied thereto. The reflecting facets 66 other than the reference facet 66B exhibit a high reflectance of 99.5% with respect to a light beam having a wavelength of 355 nm. Therefore, when the laser beam 50 (see FIGS. 3 and 4) having the wavelength of 355 nm is applied to the reflecting facets 66 other than the reference facet 66B, the laser beam 50 is reflected with the high reflectance. Accordingly, the laser beam 50 is prevented from being absorbed by or transmitted through the reflecting facets 66 other than the reference facet 66B, and is efficiently applied to the workpiece 11.

FIG. 6B is a graph illustrating the reflectance of the reference facet 66B of the polygon mirror 64 with respect to light beams applied thereto. The reference facet 66B exhibits a high reflectance of 99.9% with respect to a light beam having a wavelength of 355 nm, as with the reflecting facets 66 other than the reference facet 66B. Consequently, when the laser beam 50 having the wavelength of 355 nm is applied to the reference facet 66B, the laser beam 50 is reflected with the high reflectance, and the laser beam 50 is prevented from being absorbed by or transmitted through the reference facet 66B.

The reference facet 66B also exhibits a high reflectance of 75.6% with respect to a light beam having a wavelength of 650 nm. In other words, with respect to the light beam having the wavelength of 650 nm, the reflectance of the reference facet 66B is higher than the reflectance, illustrated as 14.8% in FIG. 6A, of the reflecting facets 66 other than the reference facet 66B. Therefore, when the light beam 92a (see FIG. 3) having the wavelength of 650 nm is emitted from the light emitting unit 92 and applied to the reference facet 66B, the light beam 92a is reflected with the high reflectance. Consequently, the amount of light of the reflected light beam that is detected by the light detecting unit 94 is relatively large.

As described above, the reflectance of the reference facet 66B with respect to the light beam 92a emitted from the light emitting unit 92 is different from the reflectance of the reflecting facets 66 other than the reference facet 66B with respect to the light beam 92a. Therefore, the amount of light of the reflected light beam that is detected by the light detecting unit 94 is different depending on whether the light beam 92a is applied to the reference facet 66B or the reflecting facets 66 other than the reference facet 66B. The reference facet 66B and the reflecting facets 66 other than the reference facet 66B can thus be distinguished from each other on the basis of the amount of light detected by the light detecting unit 94. In order to clearly distinguish the reference facet 66B and the reflecting facets 66 other than the reference facet 66B from each other on the basis of the amount of light detected by the light detecting unit 94, one of the reflectance of the reference facet 66B with respect to the light beam 92a and the reflectance of the reflecting facets 66 other than the reference facet 66B with respect to the light beam 92a should preferably be at least twice larger than the other, and more preferably, be at least three times larger than the other. The light detecting unit 94 outputs an electric signal representing the amount of light detected by the light detecting unit 94, i.e., an amount-of-detected-light signal, to the controller 44.

The components of the laser beam applying unit 36 illustrated in FIG. 3, e.g., the laser oscillator 52, the output regulating unit 54, the position adjusting unit 58, the rotary actuator 68 coupled to the polygon mirror 64, the light emitting unit 92, and the light detecting unit 94, are electrically connected to the controller 44. The controller 44 outputs control signals to these components to control them.

When the laser beam 50 is applied to the workpiece 11, the regions of the workpiece 11 that are irradiated with the laser beam 50 are melted, producing meltage or debris. If the meltage is resolidified, it refills or recasts the melted regions, tending to disrupt efficient laser beam processing. However, when the workpiece 11 is scanned with the laser beam 50 at a high speed repeatedly a number of times by applying the laser beam 50 to the polygon mirror 64 that is being rotated at a high speed, it is possible to process the workpiece 11 with the laser beam 50 while preventing the meltage from being resolidified.

Ideally, the polygon mirror 64 should be shaped as a regular polygonal prism having all the reflecting facets 66 lying parallel to the rotational axis 64a (see FIG. 4) about which the polygon mirror 64 rotates. Actually, however, because of errors that are liable to occur when the polygon mirror 64 is manufactured, it is difficult to equalize the angles of all the reflecting facets 66 with respect to the rotational axis 64a of the polygon mirror 64, and the angles of the reflecting facets 66 with respect to the rotational axis 64a of the polygon mirror 64 tend to suffer slight variations. For example, FIG. 4 illustrates the reflecting facet 66f as being slightly oblique to and hence not parallel to the rotational axis 64a of the polygon mirror 64. When the reflecting facet 66f thus slanted becomes the irradiated facet 66A, it reflects the laser beam 50 applied to the polygon mirror 64. The laser beam 50 reflected by the reflecting facet 66f has its focused spot displaced off a desired position, and tends to irradiate a region of the workpiece 11 that is not intended.

According to the present embodiment, the irradiated facet 66A that is irradiated with the laser beam 50 among the reflecting facets 66 of the polygon mirror 64 is specified by the irradiated facet specifying unit 80 (see FIG. 3). This makes it possible to monitor in real time which reflecting facet 66 of the polygon mirror 64 is irradiated with the laser beam 50 while the laser processing apparatus 2 is in a laser processing operation, and to adjust the position where the laser beam 50 irradiates the irradiated facet 66A with respect to each of the reflecting facets 66. As a result, the focused spot of the laser beam 50 is prevented from varying due to angle variations of the reflecting facets 66, and the laser beam 50 is prevented from irradiating a region of the workpiece 11 that is not intended.

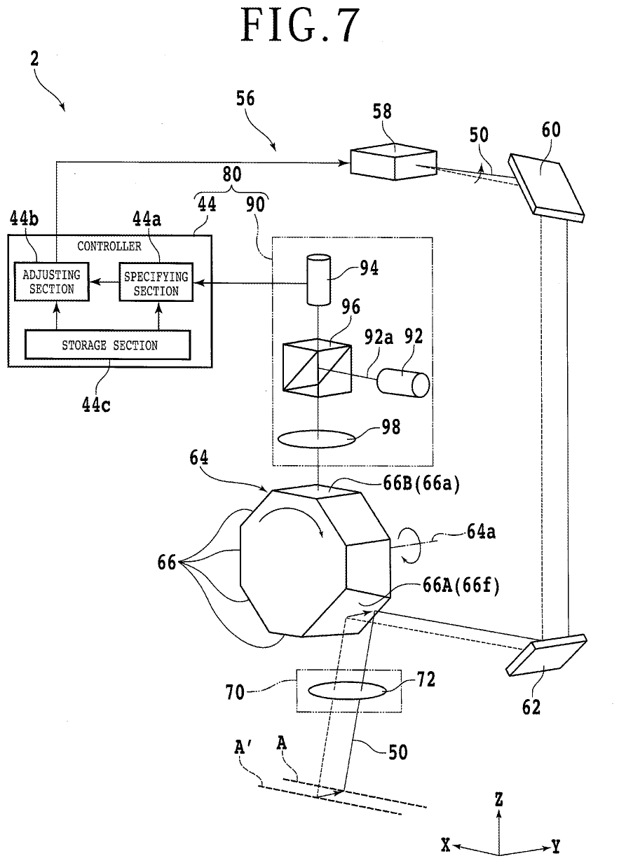

An operation performed by the laser processing apparatus 2 for adjusting the position where the laser beam 50 irradiates each of the reflecting facets 66 of the polygon mirror 64, also referred to as a method of adjusting the position where a laser beam irradiates a reflecting facet or a method of processing a workpiece, will be described below. FIG. 7 illustrates in perspective, partly in block form, the laser processing apparatus 2 as it adjusts the position where the laser beam 50 irradiates the reflecting facets 66 of the polygon mirror 64. FIG. 7 also illustrates functional blocks of the controller 44. Some of the components of the laser processing apparatus 2 are omitted from illustration in FIG. 7.

The controller 44 includes a specifying section 44a that specifies the irradiated facet 66A of the polygon mirror 64 and an adjusting section 44b that controls the position adjusting unit 58 to adjust the position to be irradiated with the laser beam 50. The controller further includes a storage section, i.e., a memory, 44c for storing various pieces of information, i.e., data and programs, which are used in processing operations of the specifying section 44a and the adjusting section 44b.

For the laser processing apparatus 2 to process the workpiece 11, information required to adjust the position to be irradiated with the laser beam 50 is stored in advance in the storage section 44c of the controller 44. Specifically, the storage section 44c stores information representing a positional relation of the irradiated facet 66A to the reference facet 66B of the polygon mirror 64, i.e., irradiated facet information, and information representing a corrective quantity for the position to be irradiated with the laser beam 50 with respect to each of the reflecting facets 66, i.e., corrective information.

The irradiated facet information represents the reflecting facet 66 that becomes the irradiated facet 66A at the time the reference facet 66B is detected by the reference facet detecting unit 90. For example, in a case where the optical system 56 is configured as illustrated in FIG. 7, the irradiated facet information indicates that the reflecting facet 66 that is positioned three facets in advance of the reference facet 66B along the direction in which the polygon mirror 64 rotates is the irradiated facet 66A. More specifically, providing the reflecting facet 66a is established as the reference facet 66B, the irradiated facet information indicates that the reflecting facet 66f is the irradiated facet 66A.

The corrective information represents a corrective quantity for the position to be irradiated with the laser beam 50, required to scan a desired position with the laser beam 50, with respect to each of the reflecting facets 66. For example, the corrective information is acquired by experimentally processing a given sample using the polygon mirror 64 and establishing a corrective quantity for the position to be irradiated with the laser beam 50 on the basis of the result of the experimental processing.

Specifically, the laser beam 50 is first applied to the given sample while scanning the given sample using the polygon mirror 64, thereby experimentally processing the given sample. The difference between a region to be processed and a region that has been actually processed is then recorded each time the laser beam 50 is applied to each of the reflecting facets 66a through 66h (see FIG. 4).

For example, as illustrated in FIG. 4, it is assumed that the reflecting facets 66a through 66e, 66g, and 66h lie parallel to the rotational axis 64a of the polygon mirror 64 and the reflecting facet 66f is slightly oblique to the rotational axis 64a due to an error that has occurred when the polygon mirror 64 is manufactured. As long as the laser beam 50 is applied to the reflecting facets 66a through 66e, 66g, and 66h, the laser beam 50 scans the sample normally along a straight path to be processed. However, when the laser beam 50 is applied to the reflecting facet 66f, the direction along which the laser beam 50 is reflected by the reflecting facet 66f is varied due to the slanting of the reflecting facet 66f, causing the laser beam 50 to be applied to the sample at a position spaced from the region of the sample to be processed. FIG. 7 illustrates a path A to be irradiated with the laser beam 50 and a path A′ that has been actually irradiated with the laser beam 50 because the direction along which the laser beam 50 is reflected by the reflecting facet 66f is varied due to the slanting of the reflecting facet 66f. While the laser beam 50 is being applied to the reflecting facet 66f, the laser beam 50 is applied to the sample along the path A′. The positional difference, i.e., an error, between the path A and the path A′ is recorded.

Then, a corrective quantity for the position where the laser beam 50 is applied to the irradiated facet 66A is determined for each of the reflecting facets 66a through 66h in order to bring the position actually irradiated with the laser beam 50 into alignment with a position to be processed on the workpiece 11. The corrective quantity thus determined for each of the reflecting facets 66a through 66h is then stored as the corrective information in the storage section 44c. For example, when the laser beam 50 is applied to the reflecting facets 66a through 66e, 66g, and 66h (see FIG. 4), the position to be irradiated with the laser beam 50 and the position that has been actually irradiated with the laser beam 50 are aligned with each other. Therefore, it is not necessary to correct the position where the laser beam 50 is applied to the polygon mirror 64 (corrective quantity=0). When the laser beam 50 is applied to the reflecting facet 66f, it is necessary to adjust the position where the laser beam 50 is applied to the reflecting facet 66f in order to bring the position actually irradiated with the laser beam 50, i.e., the path A′ in FIG. 7, into alignment with a position to be processed on the workpiece 11, i.e., the path A in FIG. 7. The variation in the position where the laser beam 50 is applied to the reflecting facet 66f at this time corresponds to the corrective quantity. The corrective quantity thus determined for each of the reflecting facets 66a through 66h with respect to the position where the laser beam 50 is applied to the polygon mirror 64 is stored as the corrective information in the storage section 44c.

Then, the laser processing apparatus 2 performs a laser processing operation on the workpiece 11. Specifically, the controller 44 first inputs a control signal to the rotary actuator 68 (see FIG. 3) to energize the rotary actuator 68, rotating the polygon mirror 64 at a high speed. The speed at which the polygon mirror 64 is rotated is not limited to any value, and may be set to approximately 500 revolutions per second, for example. The laser beam 50 emitted from the position adjusting unit 58 is reflected by the mirrors 60 and 62 and applied to the irradiated facet 66A of the polygon mirror 64. The polygon mirror 64 as it rotates reflects and scans the laser beam 50.

The reference facet detecting unit 90 is energized to detect the reference facet 66B of the polygon mirror 64. Specifically, the light beam 92a emitted from the light emitting unit 92 is applied via the polarizing beam splitter 96 and the lens 98 successively to the reflecting facets 66 of the polygon mirror 64 and reflected successively by the reflecting facets 66. At the time when the direction of travel of the light beam 92a from the lens 98 toward each of the reflecting facets 66 and the reflecting facet 66 become generally perpendicular to each other, the light beam reflected from the light beam 92a by the reflecting facet 66 travels via the lens 98 and the polarizing beam splitter 96 to the light detecting unit 94, which detects the reflected light beam. The light detecting unit 94 generates an electric signal representing the amount of light of the reflected light beam thus detected, and outputs the generated electric signal to the specifying section 44a of the controller 44. As described above, the reflectance with respect to the light beam 92a emitted from the light emitting unit 92 is different and hence the amount of light of the reflected light beam that is detected by the light detecting unit 94 is different depending on whether the light beam 92a is applied to the reference facet 66B or the reflecting facets 66 other than the reference facet 66B. The specifying section 44a determines whether the reflecting facet 66 detected by the reference facet detecting unit 90 is the reference facet 66B or not on the basis of the signal, representing the detected amount of light, input from the light detecting unit 94. For example, the specifying section 44a compares the amount of light detected by the light detecting unit 94 and a predetermined reference value stored in the storage section 44c with each other to determine whether the reflecting facet 66 to which the light beam 92a is applied is the reference facet 66B or not.

When the specifying section 44a determines the reflecting facet 66a detected by the reference facet detecting unit 90 as the reference facet 66B, the specifying section 44a refers to the irradiated facet information stored in the storage section 44c and specifies the irradiated facet 66A that is irradiated with the laser beam 50 among the reflecting facets 66. Then, the specifying section 44a outputs an electric signal representing the irradiated facet 66A, i.e., an irradiated facet signal, to the adjusting section 44b. Specifically, when the reference facet detecting unit 90 detects the reflecting facet 66a, the specifying section 44a refers to the irradiated facet information and specifies the reflecting facet 66f as the irradiated facet 66A, and outputs an irradiated facet signal indicating that the reflecting facet 66f is the irradiated facet 66A to the adjusting section 44b.

Thereafter, the specifying section 44a sequentially inputs irradiated facet signals to the adjusting section 44b. For example, on the basis of the rotational angle of the polygon mirror 64 or the elapsed time after the reference facet detecting unit 90 has detected the reference facet 66B, the specifying section 44a successively outputs irradiated facet signals representing reflecting facets that have become the irradiated facet 66A among the reflecting facets 66a through 66h, in real time to the adjusting section 44b. Specifically, each time the polygon mirror 64 turns 45°, the irradiated facet signal input from the specifying section 44a to the adjusting section 44b switches over.

The adjusting section 44b refers to the corrective information stored in the storage section 44c, and sequentially outputs electric signals, i.e., corrective signals, representing corrective quantities for the position where the laser beam 50 is to be applied to the reflecting facets 66 represented by the irradiated facet signals to the position adjusting unit 58. For example, if the specifying section 44a inputs an irradiated facet signal indicating that the reflecting facet 66f is the irradiated facet 66A to the adjusting section 44b, then the adjusting section 44b refers to the corrective information stored in the storage section 44c, and outputs a corrective quantity for the position where the laser beam 50 is to be applied to the reflecting facet 66f to the position adjusting unit 58.

At the time when the laser beam 50 is actually applied to the reflecting facet 66f, the position adjusting unit 58 corrects the position where the laser beam 50 is applied to the reflecting facet 66f. In this manner, the position where the laser beam 50 is applied to the irradiated facet 66A is adjusted on each of the reflecting facets 66a through 66h. As a result, while the laser beam 50 is scanning the workpiece 11, the position of the focused spot of the laser beam 50 on the workpiece 11 is corrected, enabling the laser beam 50 to scan the workpiece 11 along the path A where the laser beam 50 is to be applied to the workpiece 11. In FIG. 7, the path along which the laser beam 50 travels from the position adjusting unit 58 to the workpiece 11 before the position where the laser beam 50 is applied is corrected is indicated by broken lines, whereas the path along which the laser beam 50 travels from the position adjusting unit 58 to the workpiece 11 after the position where the laser beam 50 is applied has been corrected is indicated by solid lines.

The workpiece 11 is processed by the laser beam 50 whose applied position has been corrected as described above. For example, the laser beam 50 is applied to the workpiece 11 along one at a time of the streets 13 (see FIG. 2) thereon, ablating the workpiece 11 along the streets 13 to divide the workpiece 11 along the streets 13. At this time, the laser beam 50 is applied successively to the reflecting facets 66 of the rotating polygon mirror 64 and reflected thereby to scan the workpiece 11 along the streets 13.

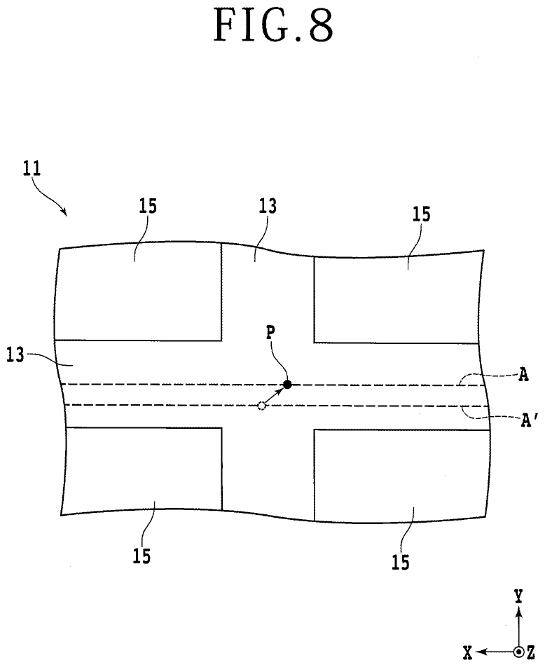

FIG. 8 illustrates the workpiece 11 in enlarged fragmentary plan. For performing a laser processing operation on the workpiece 11 along one of the streets 13, the path A is established, for example, centrally on the street 13 across its width. The position where the laser beam 50 is to scan the street 13 is established to place the focused spot, denoted by P, of the laser beam 50 in alignment with the path A. However, if the reflecting facets 66 of the polygon mirror 64 suffer angle variations, then the focused spot P of the laser beam 50 is positioned on the path A′ that deviates from the path A. When the laser beam 50 is applied to scan the street 13 along the path A′, it ablates the workpiece 11 along the path A′, i.e., at deviating positions, possibly causing processing failures such as damage to the devices 15 and dimensional variations of the device chips. According to the present embodiment, however, the position where the laser beam 50 is applied to the irradiated facet 66A is adjusted to correct the position of the focused spot P of the laser beam 50 reflected by the oblique reflecting facet 66 to shift the laser beam 50 from the path A′ to the path A. Therefore, even if the angle of any of the reflecting facets 66 suffers a variation, the laser beam 50 can scan the workpiece 11 while keeping the focused spot P positioned on the path A. As a consequence, the accuracy with which the workpiece 11 is processed by the laser beam 50 is increased, preventing processing failures from occurring.

The position where the laser beam 50 is applied to the workpiece 11 along the X-axis may be adjusted by changing the time at which the laser beam 50 is applied to the polygon mirror 64. Specifically, the position where the laser beam 50 is applied to the workpiece 11 along the X-axis may be adjusted or controlled by adjusting the times when the laser beam 50 is turned on and off, i.e., the times at which the direction of travel of the laser beam 50 emitted from the position adjusting unit 58 changes from the mirror 60 toward the beam damper 74 and from the beam damper 74 toward the mirror 60 as illustrated in FIG. 3.

The applied position of the laser beam 50 may be adjusted as described above by executing a program stored in the storage section 44c of the controller 44. Specifically, the storage section 44c stores a program for generating control signals for actuating the components of the laser beam applying unit 36 according to the procedure described above. The controller 44 reads and executes the program to automatically adjust the applied position of the laser beam 50.

As described above, the laser processing apparatus 2 according to the present embodiment includes the irradiated facet specifying unit 80 for specifying the irradiated facet 66A to be irradiated with the laser beam 50 among the reflecting facets 66a through 66h of the polygon mirror 64. The irradiated facet specifying unit 80 can monitor the position where the laser beam 50 is applied to the polygon mirror 64 when the laser processing apparatus 2 performs a laser processing operation on the workpiece 11. The laser processing apparatus 2 according to the present embodiment also includes the position adjusting unit 58 for adjusting the position where the laser beam 50 is applied to the irradiated facet 66A with respect to each of the reflecting facets 66. The position adjusting unit 58 makes it possible to restrain the focused spot of the laser beam 50 from varying in position due to angle variations of the reflecting facets 66, thus preventing processing failures from occurring.

According to the embodiment described above, one of the reflecting facets 66 of the polygon mirror 64 is established as the reference facet 66B. However, the polygon mirror 64 is not limited to such a setup. Rather than establishing the reference facet 66B, for example, all of the reflecting facets 66 may be arranged to have respective different reflectances with respect to the light beam 92a (see FIGS. 3 and 7). With such an arrangement, the amount of light detected by the light detecting unit 94 is different from one reflecting facet 66 to another reflecting facet 66 to which the light beam 92a is applied. Therefore, the specifying section 44a is able to specify the reflecting facet 66a to which the light beam 92a is applied on the basis of the amount of light detected by the light detecting unit 94.

The irradiated facet 66A of the polygon mirror 64 may be specified by methods other than the method described above that uses the reference facet detecting unit 90. For example, instead of detecting the reflecting facets 66 of the polygon mirror 64 with the reference facet detecting unit 90, the irradiated facet 66A may be specified on the basis of an angular displacement of the rotary actuator 68 (see FIG. 3) that rotates the polygon mirror 64. Specifically, the rotary actuator 68 incorporates therein or is connected to an encoder, not depicted, for detecting the angular displacement of an output shaft of the rotary actuator 68, i.e., an angular displacement of the polygon mirror 64. Information, i.e., irradiated facet information, representing a positional relation between angular displacements of the output shaft of the rotary actuator 68 and the irradiated facet 66A is preset and stored in the storage section 44c of the controller 44. When the rotary actuator 68 is energized to rotate the polygon mirror 64, the angular displacements of the output shaft of the rotary actuator 68 are sequentially measured by the encoder and input to the controller 44. The controller 44 specifies the irradiated facet 66A on the basis of the angular displacements measured by the encoder and the irradiated facet information. Consequently, the irradiated facet 66A of the polygon mirror 64 can be specified without the reference facet detecting unit 90. The laser beam applying unit 36 that is free of the reference facet detecting unit 90 may be simpler in configuration.

The structural and methodical details according to the above embodiment may be changed or modified without departing from the scope of the present invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus comprising:
a holding table for holding a workpiece thereon;
a laser oscillator for emitting a laser beam;
a polygon mirror having a plurality of reflecting facets and scanning the laser beam emitted by the laser oscillator;
a beam condenser for converging the laser beam scanned by the polygon mirror and applying the converged laser beam to the workpiece; and
an irradiated facet specifying unit for specifying an irradiated facet of the polygon mirror to which the laser beam is applied among the reflecting facets.

2. The laser processing apparatus according to claim 1, further comprising:
a position adjusting unit for adjusting a position where the laser beam is applied to the irradiated facet with respect to each of the reflecting facets.

3. The laser processing apparatus according to claim 1, wherein the irradiated facet specifying unit includes a reference facet detecting unit for detecting a predetermined reference facet from among the reflecting facets, and the irradiated facet specifying unit specifies the irradiated facet on a basis of the reference facet.

4. The laser processing apparatus according to claim 3, wherein the reference facet detecting unit includes a light emitting unit for emitting a light beam to be applied to the reflecting facets and a light detecting unit for detecting the light beam reflected by the reflecting facets,
the reference facet has a reflectance different from a reflectance of the reflecting facets other than the reference facet with respect to the light beam applied to the reflecting facets, and
the irradiated facet specifying unit specifies the reference facet on a basis of an amount of light of the light beam detected by the light detecting unit.
